(19) United States
(12) Patent Application Publication
(10) Pub. No.: US 2005/0243042 A1
(43) Pub. Date: Nov. 3, 2005

(54) Method and apparatus for LED based display

(76) Inventor: Shiraz M. Shivji, Saratoga, CA (US)

Correspondence Address: HEIMLICH LAW, 5952 DIAL WAY, SAN JOSE, CA, 95129, US

(21) Appl. No.: 11/172,495

(22) Filed: Jun. 30, 2005

Related U.S. Application Data
(60) Provisional application No. 60/584,920, filed on Jul. 1, 2004.

(51) Int. Cl. G09G 3/32

(52) U.S. Cl. 345/82

(57) ABSTRACT

A method and apparatus for a light emitting diode based display have been disclosed.

### RELATED APPLICATION

This patent application claims priority of U.S. Provisional Application Ser. No. 60/584920 filed Jul. 01, 2004 titled “Method and Apparatus for LED Based Display”, which is hereby incorporated herein by reference. This patent application is related to U.S. application Ser. No. 10/810300 filed Mar. 26, 2004 titled “Method and Apparatus for Light Emitting Devices Based Display”, which is by the same inventor as this application.

### FIELD OF THE INVENTION

The present invention pertains to displays. More particularly, the present invention relates to a method and apparatus for a LED (light emitting diode) based display.

### BACKGROUND OF THE INVENTION

Displays are an integral part of conveying information. Many different technologies are being utilized for electronic color displays. CRT (Cathode Ray Tube) based displays are very commonly used in the home (for television and computer monitors) as well as in offices, factories, commercial establishments, and public places (such as airports and shopping malls). However, CRT's are big, bulky, and consume large amounts of power. This may present a problem.

LCD based displays are extensively used in very portable devices such as cell phones, mobile PCs, mobile games, and portable televisions. Recently LCD based display screens have been taking a much bigger role as display devices in offices and homes as monitors for computers and are replacing the ubiquitous CRT as a display of choice. Large thin flat screen displays based on plasma technology, and backlit LCD displays are becoming very popular although they are relatively expensive at present. This expense may present a problem.

Projection displays using SLM (spatial light modulators such as LCDs, Digital Mirror Devices or LCOS devices) are used in front projection mode. These devices may require a high power light source such as a projection lamp. This may present a problem.

Rear view projection devices, such as very large screen televisions may be based on power hungry CRTs. This may present a problem.

LEDs are now available and many large outdoor displays are built with LEDs. This requires the use of a very large number of red, green and blue LEDs. FIG. 3 shows a fixed LED based M×N display that has a total of 3×M×N LEDs. For example, a display resolution of 1024 by 1024 will require the use of over 1 million red, over 1 million green and over 1 million blue LEDs. Thus very large outdoor displays based on LEDs are complex and quite expensive. This may present a problem.

Thus all these displays present a problem.

### BRIEF DESCRIPTION OF THE DRAWINGS

The invention is illustrated by way of example and not limitation in the figures of the accompanying drawings in which:

FIG. 1 illustrates a network environment in which the method and apparatus of the invention may be implemented;

FIG. 2 is a block diagram of a computer system which may be used for implementing some embodiments of the invention;

FIG. 3 shows a prior approach;

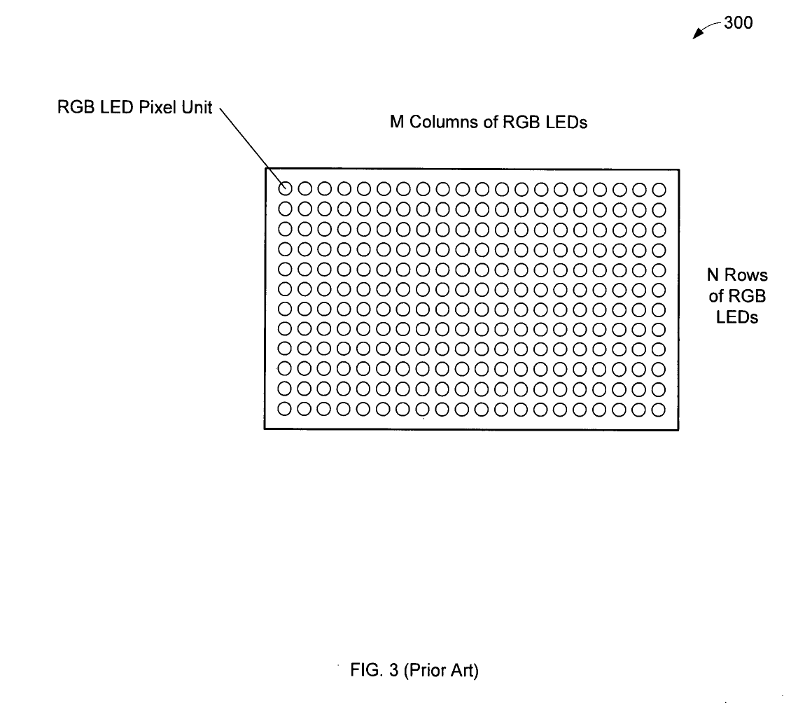

FIG. 4 illustrates one embodiment of the invention showing a direct display;

FIG. 5 illustrates one embodiment of the present invention in block diagram form;

FIG. 6 illustrates one embodiment of the invention showing more details of a substrate;

FIG. 7 shows an embodiment of the invention minimizing the total excursion of the substrate by using multiple Red, Green, and Blue LED columns;

FIG. 8 illustrates one embodiment of the present invention using sinusoidal motion;

FIG. 9 illustrates one embodiment of the invention using projection optics;

FIG. 10 illustrates two embodiments of the invention creating a flat panel display; and

FIG. 11 shows one embodiment of the invention illustrating increasing the color gamut.

### DETAILED DESCRIPTION

This design, as exemplified in various embodiments of the invention, illustrates how LEDs (light emitting diodes) may be used to create a display. There are a variety of light emitting diodes, for example, light emitting diodes (commonly referred to as LEDs), resonant cavity light emitting diodes (RCLEDs), organic light emitting diodes (OLEDs), electroluminescent diodes (ELDs), photon recycling semiconductor light emitting diode, etc.

The phenomena of electroluminescence caused by carrier injection in semiconductors was discovered by Round (in 1907) who injected carriers into silicon carbide from a metal contact and observed a yellowish light. The red LED was invented by Holonyak and Bevacqua (in 1962) and soon saw widespread use in instruments and consumer products such as calculators and watches. The early LEDs were not very bright and it was difficult to produce bright blue and green LEDs. Improvements in the manufacturing processes and better understanding of the mechanisms of producing light in solid state devices as well as the minimization of losses is leading to brighter devices every year. There are several advantages to using LEDs in displays. Very good quality emissive displays may be built using LEDs. Emissive displays typically use less power than non-emissive type displays such as backlit LCDs or projection displays using SLMs. This is due to the fact that in a typical frame that is displayed only a fraction of the screen, say, between 10 to 20% is displayed at maximum power. On the other hand, to get maximum brightness, a backlit display has the backlight turned up to the maximum all the time. This also leads to a better contrast ratio for emissive displays because when an area of the screen is not to be displayed the light for that portion of the screen is not created. It is impossible to completely shut off the light in backlit displays thus leading to lowered contrast ratios.

Another advantage of using bright red, green, and blue LEDs for displays is that it is possible to build color displays with a larger color gamut than the NTSC standard, for example, using inexpensive and readily available Red (626 nm using AlGaInP LED), Green (525 nm using GaInN LED), and Blue (450 nm using GaInN LED) devices. Additionally, Haitz's Law which has held true for more than 30 years predicts a doubling in LED luminous output every 18 to 24 months.

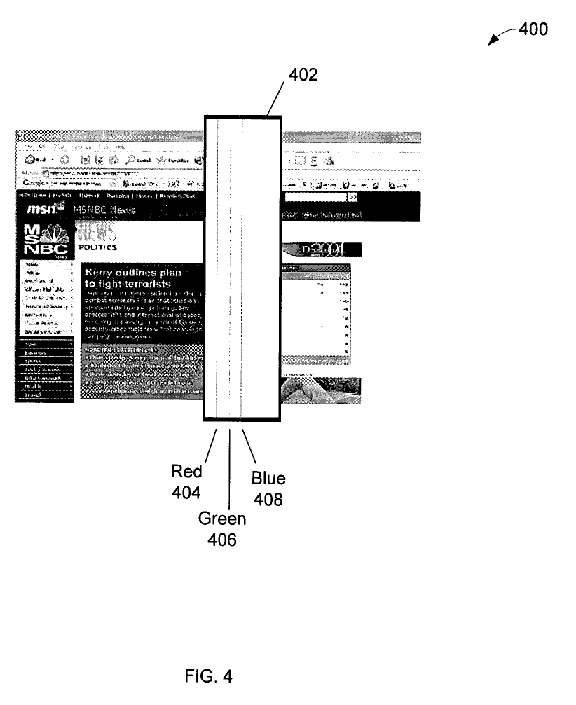

In one embodiment of the invention 400, as illustrated in FIG. 4, a colored display is generated by exciting columns of Red (404), Green (406), and Blue (408) LEDs mounted on a substrate (402) and moving the substrate at appropriate speeds. The duration of the excitation is dependent on the position of the substrate, the velocity of the motion and the information content to be displayed. FIG. 4 shows a view of such a display where the substrate (402) is shown in exaggerated form for illustration purposes. This is a direct view display as the display in this embodiment of the invention is meant for direct viewing.

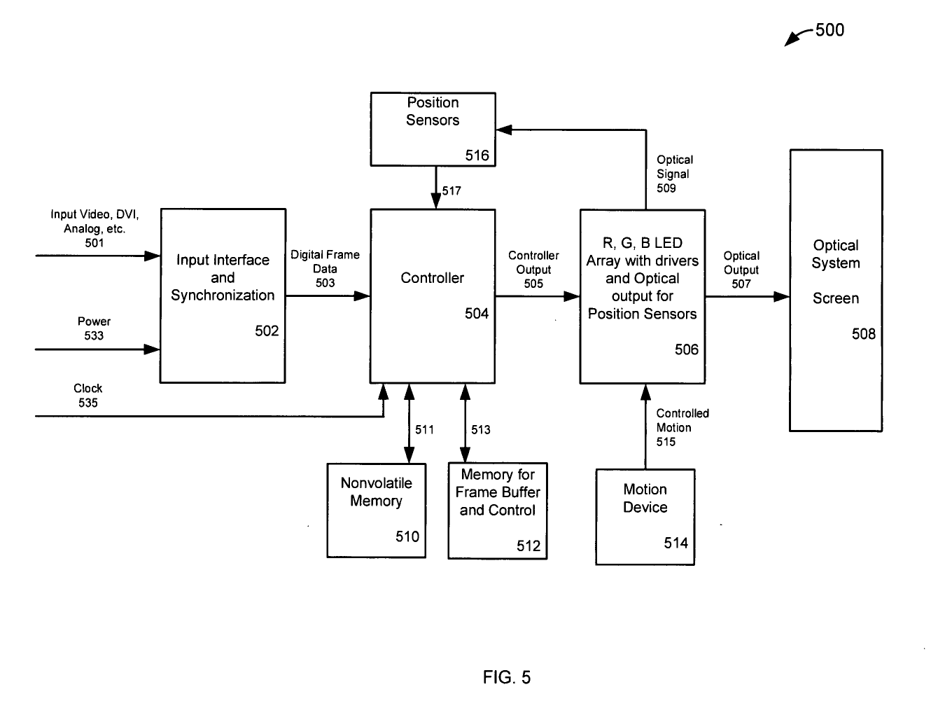

FIG. 5 illustrates one embodiment 500 of the present invention in block diagram form showing an LED based display. Shown as input 501 is a video signal that is provided by an electronic system. This signal may follow a standard format such as VESA (Video Electronics Standard) and may be in analog or digital form. A new digital standard is the DVI (Digital Visual Interface) standard. If the input video to the system is analog, the input interface and synchronization section 502 will convert the analog RGB signals into digital versions 503.

Another input from the outside is power 533 for the drive and display electronics. The digital video information 503 is fed into the controller 504. A clock 535 at a high frequency (for example, from 40 MHz to 200 MHz) is provided to the controller 504. The controller 504 interfaces (via 511) to nonvolatile memory 510 and interfaces (via 513) to random access memory 512. The RAM (random access memory) 512 is used to store a complete frame of information. The nonvolatile memory 510 is used to store various parameters required in the running of the system. For example, when the RGB LED arrays are assembled, testing is performed on them to check the uniformity of the brightness of the LEDs. The slight differences in brightness (5-10%) are stored in the nonvolatile memory 510, such as flash, to allow for compensation. The actual distance between the columns is found during the testing as well and is stored in the nonvolatile memory 510.

In one embodiment of the present invention, any gamma corrections, if necessary, are made on the data, for example in the controller 504. The nonvolatile memory 510 has information on the characteristics of the motion as produced by the motion device 514 which is communicated via 515 to the LED array 506. This allows the controller 504 to calculate the time when a particular column is turned on and the width of the pulse for a particular pixel. The controller 504 receives position information 517 from the position sensors 516. In one embodiment of the invention, a linear encoder is used to determine position. In another embodiment, a VCSEL is used as a very narrow beam precision light source (such as optical signal 509) at, for example, 850 nm mounted on the moving substrate (such as 506) and photo-detectors (such as at 516) covered with a high pass filter in wavelength (cutoff at 800 nm) filters at fixed positions. The photo-detector signals 517 are sent to the controller. When the display device is being assembled (in manufacturing) tests for calibrations are made to get precise distance information of the fixed position mounted detectors. This data is stored in the nonvolatile memory 510. The advantage of this approach is that the position information is obtained in a “weight-less” way from the substrate; using the linear encoders on the substrate would require many more connections (such as 505) from the substrate (which may hold LED array 506) to the controller 504. It is important to minimize the number of signals (such as 505) from the substrate (such as 506) to the controller (such as 504). The LED array 506 produces an optical output 507 which is communicated to an optical system 508 such as a screen for display.

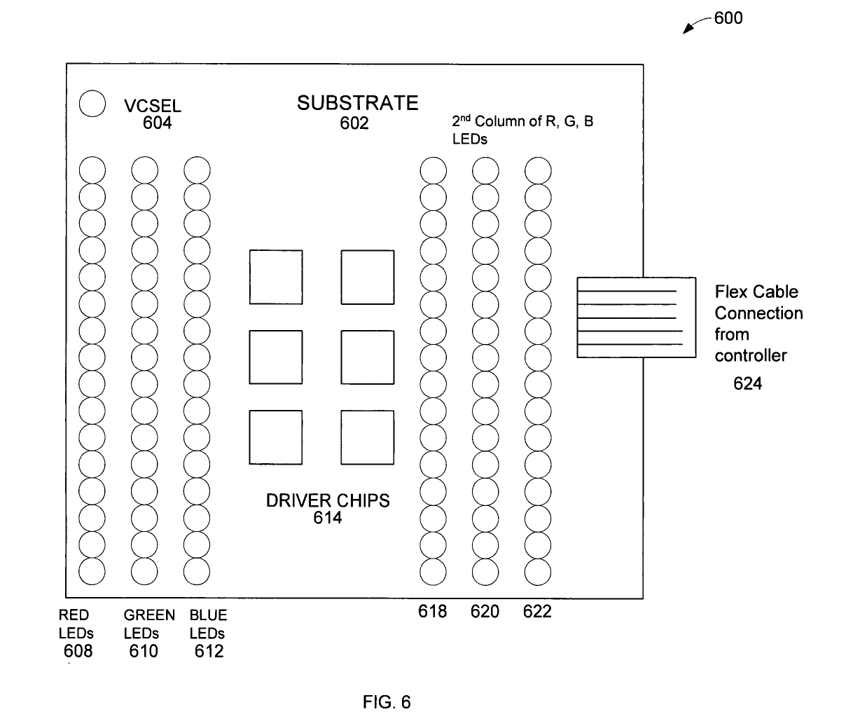

FIG. 6 illustrates one embodiment 600 of the invention showing more details of a substrate 602. The substrate 602 has mounted on it: a VCSEL 604; a first array of LEDs column 608 of Red LEDs, column 610 of Green LEDs, and column 612 of Blue LEDs; a second array of LEDs column 618 of Red LEDs, column 620 of Green LEDs, and column 622 of Blue LEDs; six driver chips 614 for driving the first (608, 610, 612) and second (618, 620, 622) of LEDs; and a connection 624 from components on the substrate 602 to a controller (such as 504 in FIG. 5).

In one embodiment of the present invention, the operation of an LED based display device is as follows:
1. A frame of the video display is captured and stored in the RAM in the device.
2. Gamma corrections and adjustments to the intensity values for the red, green and blue LED pixels is made to the data and stored.
3. The substrate housing the columns of R, G, and B LEDs will start from the extreme left position.
4. The LED excitation information is sent to the substrate to be stored in the buffers present in the driver chips. Data for several columns (1-8) is stored in the driver chips. The chips are organized by color, i.e. a driver chip for the red, a different driver chip for the green, and another for the blue. This way of organizing the drivers is done because the different colored LEDs require different driving (voltages, current, etc.). For example, the red LEDs, are in the same column which is different from the other colors. Two pieces of information are required for any column (red, green, or blue). The first is the timing information which is the same for the entire column. Second, each LED in the column requires a number that is based on the video display information sent and relates to the width of the pulse for that particular LED and pixel.
5. Free running counters in each of the driver chips is reset to zero and the first column of LEDs is energized as soon as the reset signal is removed. This will ensure that all the driver chips are synchronized and start with the same time base.
6. Energizing of the LEDs occurs in sequence so that the proper signal values are used at the appropriate time. For example, if the LED columns are vertically arranged R, G, B (with B being the rightmost column) the proper blue column LEDs are energized at time zero for creating a first visible vertical column, the proper green LEDs are energized at the appropriate time (after the blue LEDs as the substrate is moving left to right) with the proper green values for the first visible vertical column and then at a later time the blue column is energized. Thus, in one embodiment, as each column of LEDs is at the same position, the proper LEDs are illuminated to create a vertical visual display line (or column).
7. The controller keeps sending the time and excitation data for the red, green, and blue columns in a pipe-lined manner until the total scan of the image is accomplished. The position sensors and knowledge of the motion characteristics will let the controller know when the scan is done.
8. The sequence is now repeated, however, this time the substrate is moving from right to left.
This sequence is repeated, typically 30 times a second. This means that a full pass from left to right or from right to left occurs at 60 times a second. Due to the persistence characteristics of human vision, a pleasing display is seen by the viewer. This technique is not restricted to run at 60 frames a second. It is possible to run the display at higher or lower rates. For example, to create a 3D display the substrate may move 120 times per second with 60 of the “frames” displaying a left eye image and 60 of the “frames” displaying a right eye image in synchronization with, for example, LCD switching goggles.
A screen made of plastic, for example, is used for physical stability and protection of the device, and may additionally have optical coatings (such as anti-reflective).

One of skill in the art will notice an advantage for this approach compared to the fixed M×N display in that the individual red, green, and blue LEDs are not distinguishable by the human eye. In the fixed display when white is displayed, for example, one can notice the white color with spots of red, green, and blue. With this embodiment of the invention, the red, green, and blue LEDs are organized in columns, however because of the motion of the substrate the excitation of the LEDs is designed so that although the columns are spaced physically apart, the excitation is made sequentially in time so that the colors coincide in space.

In one embodiment of the present invention, the majority of the energy required to form the display is that required for lighting up the LEDs and that required for moving the substrate (mechanical energy). The kinetic energy of a moving carriage and substrate of mass m (in kg) and moving at a fixed velocity v (in m/sec) is given by Equation 1:
Kinestic Energy=½ mv² (Equation 1)

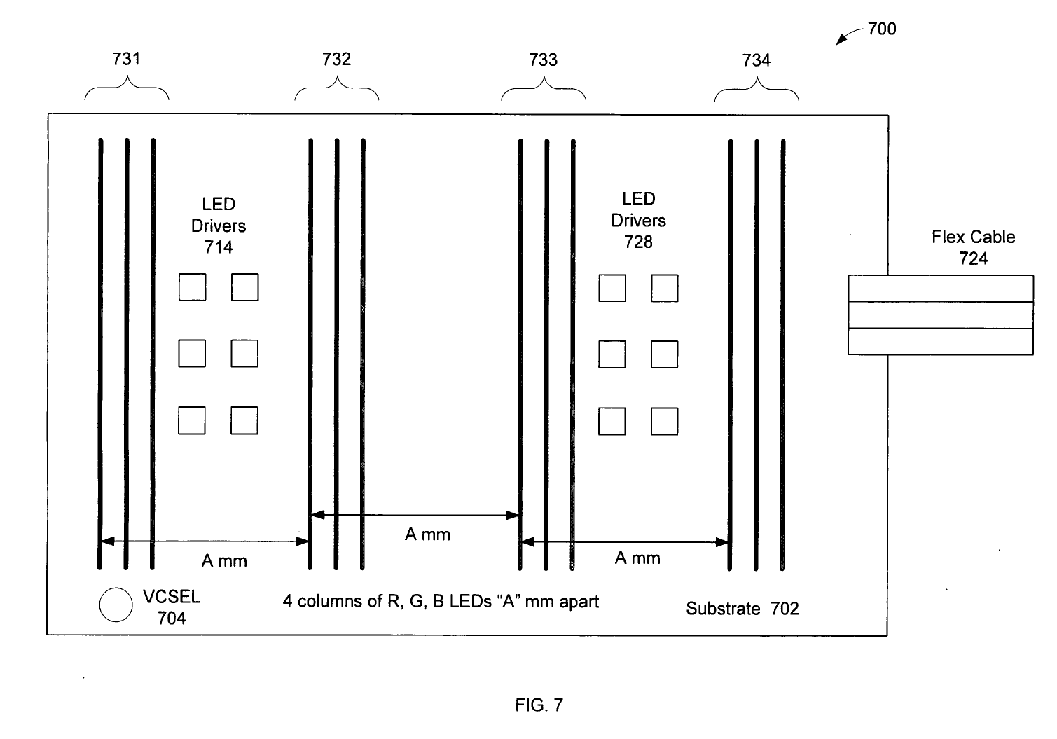

In one embodiment of the invention, to minimize energy, we minimize m and especially v. The time required to scan a full frame is usually fixed and so the velocity v can be reduced by reducing the total excursion of the carriage and substrate. This may be done by using multiple columns of RGB spaced a fixed known distance apart. FIG. 7 illustrates one embodiment 700 of the invention where this approach is shown.

FIG. 7 shows an approach 700 to minimizing the total excursion of the substrate 702 by using multiple Red, Green, and Blue LED columns 731, 732, 733, and 734. For example, if one is creating a 1280×1024 display, and if one uses 4 columns of RGB LEDs spaced a distance “A” mm apart, each column can display a 320×1024 slice of the total display (320×4=1280). The columns 731, 732, 733, and 734 do not have to be equally spaced to display exactly 320 columns. That is the distance A may intentionally be made a different value. During manufacturing the exact distance between columns is measured and the appropriate parameters entered in nonvolatile memory so that the controller can compensate and allow each quartile to display 320 +/−x columns where x may be 0, 1, 2 or more. This allows for the creation of a seamless image by having an overlap. One other advantage of using multiple columns is that one can create very bright displays. This is because more LEDs are now being used and they are mounted over a larger area allowing for better heat removal. The substrate 702 has mounted on it: a VCSEL 704; four columns of R, G, B LEDs 731, 732, 733, and 744; two sets of six driver chips 714 and 728 for driving the four columns; and a connection 724 from components on substrate 702 to a controller (such as 504 in FIG. 5).

In one embodiment of the present invention, linear motion of the substrate is used. Linear motion of the substrate is now discussed. For example, if we are creating 50μ pixels and the pitch of the LEDs is 50μ, the LED column has to move 1024×50μ (51.2 mm) for a 1024 pixel display with one set of columns of LEDs. With 4 sets of columns of RGB LEDs the total motion is 51.2/4 mm (12.8 mm). The motion is over a time period of 10 ms. The average velocity is 5.12 m/sec with 1 column and 1.28 m/sec with 4 equally spaced columns.

It is not necessary to have pure linear motion to create the image for the display. As long as the motion characteristics are precisely known, it is possible to create an image accurately by changing the time for which a particular pixel column is energized. For example, If dᵢ is the distance traveled to create pixels for the ith column, then to create equal size pixels,
dᵢ=d, a constant.
dᵢ=∫vdt (Equation 2)
where the upper limit of the integral is tᵢ and the lower limit is tᵢ₋₁ and dᵢ=distance traveled to create the ith column
ti=time when the energizing of the ith column ends
tᵢ₋₁=time when the energizing of the (i-1)th column ends.

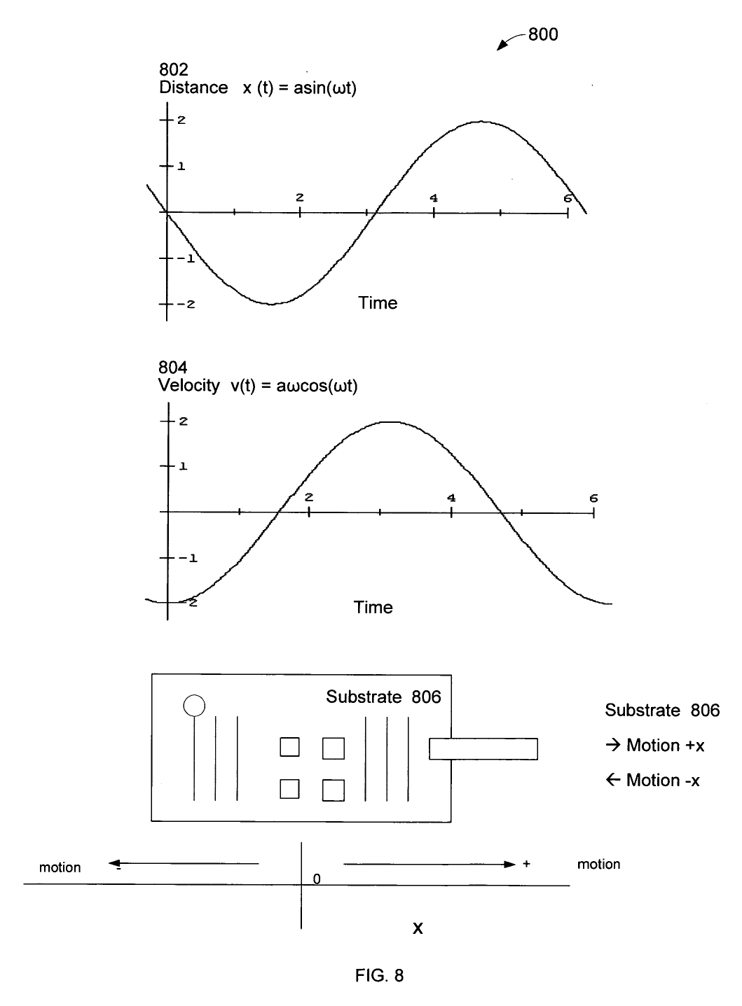

In one embodiment of the present invention, sinusoidal motion is used. This is shown in FIG. 8.

The distance x(t) (802) is given by:
x(t)=a sin(ωt) (Equation 3)

The velocity v(t) (804) is given by:

$$\begin{matrix}v ( t ) = ⅆ x / ⅆ t \\ a ωcos ( ω t ) .\end{matrix} \qquad ( Equation 4 )$$

At time zero, the substrate 806 is in the middle i.e. x(0)=0. The substrate starts moving to the left, in a negative direction, until it reaches the extreme leftmost end. At that point the velocity is zero. The substrate starts moving to the right and goes past the zero position and to the right until it reaches the extreme right position.

In one embodiment of the invention, some numbers are:
ω=2πf where f is the frequency in cycles per second.
   ω=2π30 (Equation 5)
   It is desirable to use that portion of the motion where the velocity (positive and negative) is not zero. It may be that region where ωt=2π/3 to 4π/3 for the motion to the right and ωt=5π/3 to 7π/3 for the motion to the left side which are reasonable choices.

From the equations above (Equations 2-5) it is possible for the controller to know the values of ti and tᵢ₋₁ since all the other quantities are known. The product of time and velocity is constant, so to have the same apparent size column width, when the velocity is the highest the time interval for the column energizing is the lowest. Conversely, if the velocity is low, the time interval is large. However, the longer the time interval of energizing the brighter the column may appear. Therefore, a correction that depends on the column position may have to be applied. FIG. 8 shows that the velocity is highest at the center column of the image. This suggests that the center will be less bright than the right and left extremes of the image. A correction factor can be applied to the excitation values for the LEDs to correct for this.

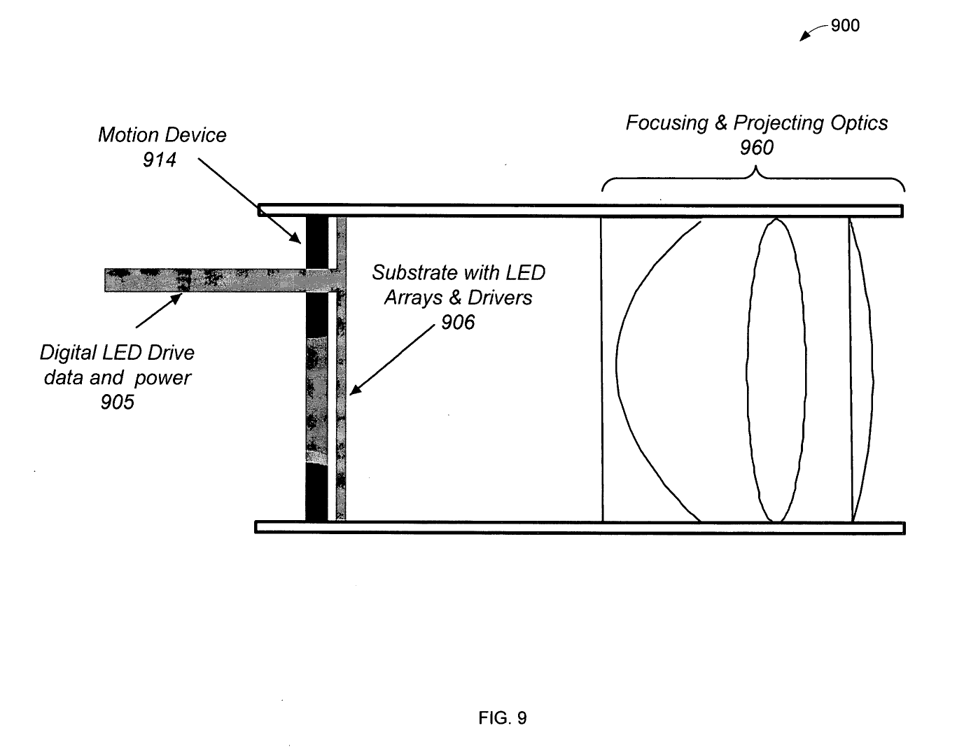

In one embodiment of the present invention an electronic projection display 900 is created using the above approach with projection optics as shown in FIG. 9. Here a cross section of a projector using LED arrays is shown. At 905 digital LED drive data and power 905 is supplied to the substrate with the LED arrays and drivers 906 which is being positioned by motion device 914. The optical output of the substrate with the LED arrays and drivers 906 is communicated to the focusing and projecting optics 960 which projects a focused image for viewing.

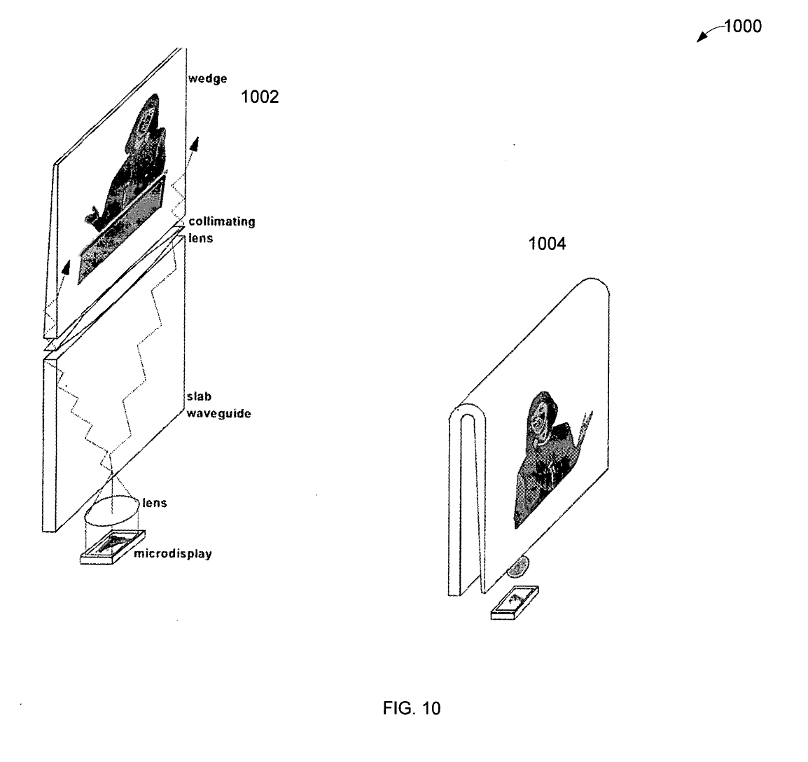

The projector type approach as illustrated above may be used in another embodiment of the present invention to create a flat panel display. Two such flat panel embodiments 1002 and 1004 of the present invention are illustrated in FIG. 10. At 1002 is shown a “straight” wedge waveguide, and at 1004 is shown a “folded” wedge waveguide. In both 1002 and 1004 the LED display is “beneath” the wedge waveguide and projecting an image into the wedge.

One of skill in the art will appreciate that the present invention as a LED projection engine may be used with other screen technologies, such as, screen waveguide technologies to create LED based flat panel displays.

The discussion above, for sake of discussion has used three LEDs; Red, Green, and Blue. The invention is not so limited. For example, to increase the color gamut of an LED display more than three LEDs may be used as well as different colors of LEDs.

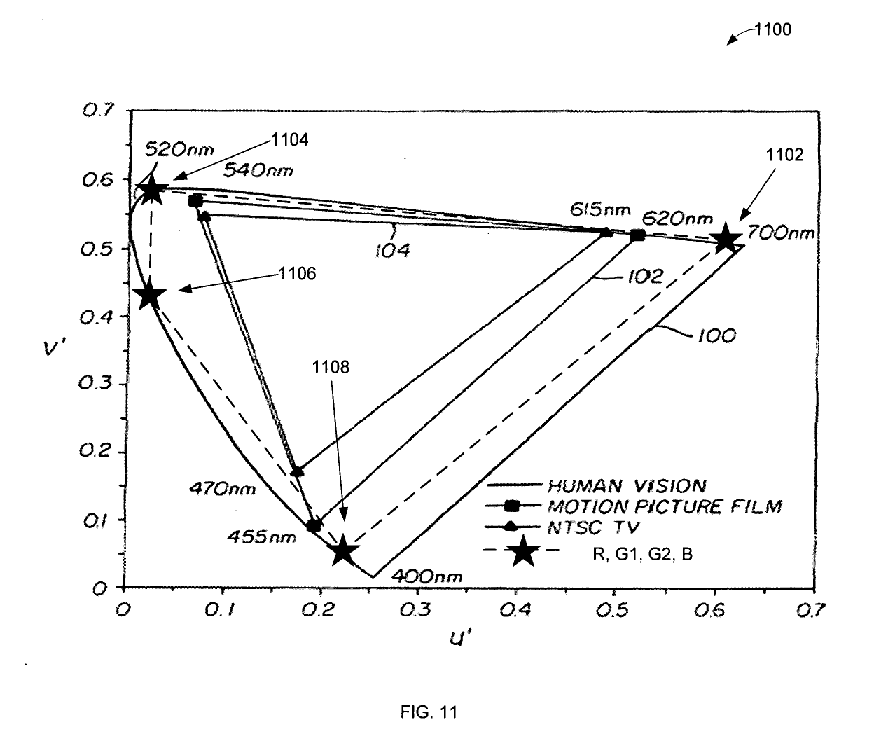

For example in one embodiment of the present invention by using columns of 4 or more LEDs at suitable wavelengths in the display system described here, the color gamut may be increased. FIG. 11 shows one embodiment 1100 of the invention illustrating the color gamut using LEDs at 660 nm (Red) 1102, 520 nm (Green1) 1104, 490 nm (Green2) 1106, and 440 nm (Blue) 1108 wavelengths. As may be seen the color gamut is increased beyond the motion picture and NTSC TV range and closer to the human vision range.

Additionally, one of skill in the art will appreciate that the techniques described above may be used with non-visible light sources as well. For example, infrared range LEDs may be used. These may be useful in fluorescing apparatuses as well as a source of radiation for other purposes, for example exposing photoresist, film, stereo lithography, etc.

One of skill in the art will appreciate that moving or positioning a substrate having LEDs may be done by a variety of methods, including but not limited to, a rail system, a cantilever system, a pendulum approach, a rotary pivot approach, etc.

Thus a method and apparatus for a light emitting diode based display have been described.

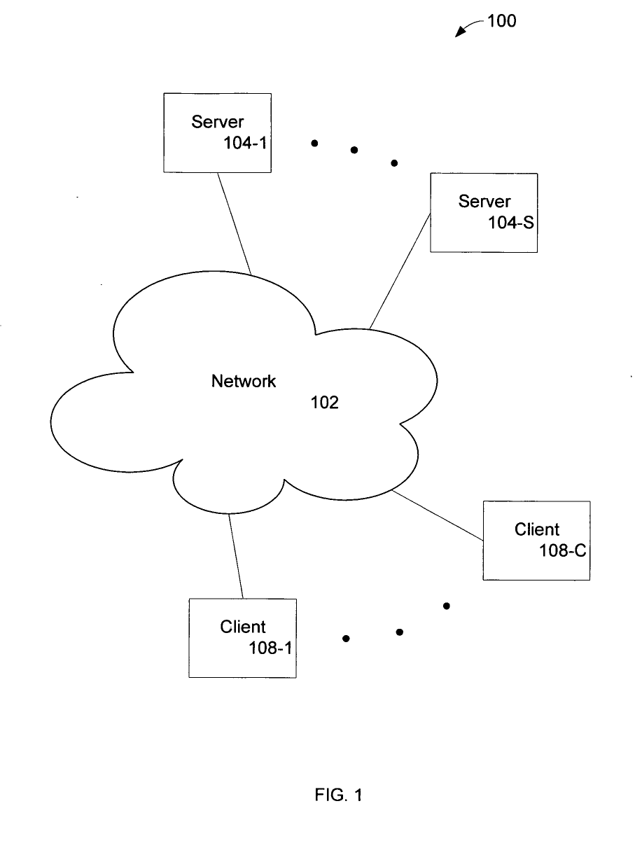

FIG. 1 illustrates a network environment 100 in which the techniques described may be applied. The network environment 100 has a network 102 that connects S servers 104-1 through 104-S, and C clients 108-1 through 108-C. More details are described below.

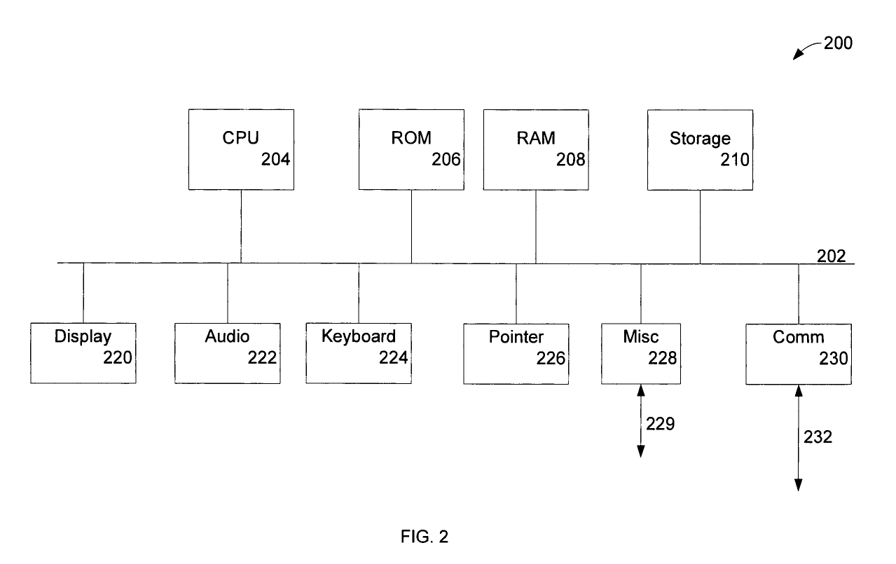

FIG. 2 illustrates a computer system 200 in block diagram form, which may be representative of any of the clients and/or servers shown in FIG. 1, as well as, devices, clients, and servers in other Figures. More details are described below.

Referring back to FIG. 1, FIG. 1 illustrates a network environment 100 in which the techniques described may be applied. The network environment 100 has a network 102 that connects S servers 104-1 through 104-S, and C clients 108-1 through 108-C. As shown, several computer systems in the form of S servers 104-1 through 104-S and C clients 108-1 through 108-C are connected to each other via a network 102, which may be, for example, a corporate based network. Note that alternatively the network 102 might be or include one or more of: the Internet, a Local Area Network (LAN), Wide Area Network (WAN), satellite link, fiber network, cable network, or a combination of these and/or others. The servers may represent, for example, disk storage systems alone or storage and computing resources. Likewise, the clients may have computing, storage, and viewing capabilities. The method and apparatus described herein may be applied to essentially any type of visual communicating means or device whether local or remote, such as a LAN, a WAN, a system bus, etc. Thus, the invention may find application at both the S servers 104-1 through 104-S, and C clients 108-1 through 108-C.

Referring back to FIG. 2, FIG. 2 illustrates a computer system 200 in block diagram form, which may be representative of any of the clients and/or servers shown in FIG. 1. The block diagram is a high level conceptual representation and may be implemented in a variety of ways and by various architectures. Bus system 202 interconnects a Central Processing Unit (CPU) 204, Read Only Memory (ROM) 206, Random Access Memory (RAM) 208, storage 210, display 220 (for example, embodiments of the present invention), audio, 222, keyboard 224, pointer 226, miscellaneous input/output (I/O) devices 228, and communications 230. The bus system 202 may be for example, one or more of such buses as a system bus, Peripheral Component Interconnect (PCI), Advanced Graphics Port (AGP), Small Computer System Interface (SCSI), Institute of Electrical and Electronics Engineers (IEEE) standard number 1394 (FireWire), Universal Serial Bus (USB), etc. The CPU 204 may be a single, multiple, or even a distributed computing resource. Storage 210, may be Compact Disc (CD), Digital Versatile Disk (DVD), hard disks (HD), optical disks, tape, flash, memory sticks, video recorders, etc. Display 220 might be, for example, an embodiment of the present invention. Note that depending upon the actual implementation of a computer system, the computer system may include some, all, more, or a rearrangement of components in the block diagram. For example, a thin client might consist of a wireless hand held device that lacks, for example, a traditional keyboard. Thus, many variations on the system of FIG. 2 are possible.

For purposes of discussing and understanding the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of ordinary skill in the art that the present invention may be practiced without these specific details. In some instances, well-known structures and devices are shown in block diagram form, rather than in detail, in order to avoid obscuring the present invention. These embodiments are described in sufficient detail to enable those of ordinary skill in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory. These algorithmic descriptions and representations are the means used by those of ordinary skill in the data processing arts to most effectively convey the substance of their work to others of ordinary skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

An apparatus for performing the operations herein can implement the present invention. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, compact disk-read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

The algorithms and displays presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of ordinary skill in the art will immediately appreciate that the invention can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. The invention can also be practiced in distributed computing environments where tasks are performed by remote processing devices that are linked through a communications network.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of ordinary skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

Thus a method and apparatus for a light emitting diodes based display have been described.

1. An apparatus comprising:
a substrate;
a plurality of columns of light emitting diodes (LEDs) mounted on said substrate;
an optical position indicator mounted on said substrate;
drivers coupled to said plurality of columns of LEDs and said optical position indicator; and
a connection from a controller to said drivers.

2. The apparatus of claim 1 wherein said substrate is moved in a repeating pattern.

3. The apparatus of claim 2 wherein said plurality of columns of LEDs are spaced a distance D apart from each other.

4. The apparatus of claim 2 wherein said plurality of columns of LEDs are spaced different distances apart from each other.

5. The apparatus of claim 1 wherein said columns of LEDs are positioned at an angle selected from the group consisting of vertically, horizontally, and diagonally.

6. The apparatus of claim 3 further comprising an optical focusing and projecting system in optical communication with said plurality of columns of LEDs.

7. The apparatus of claim 6 wherein an optical output of said optical focusing and projecting system is communicated to an entity selected from the group consisting of a flat screen, a curved screen, a straight wedge waveguide, and a folded wedge waveguide.

8. The apparatus of claim 1 wherein said plurality of columns of LEDs comprise four or more LEDs of different emitting wavelengths.

9. The apparatus of claim 2 wherein said repeating pattern allows for one or more of said plurality of columns of LEDs to overlap.

10. A method comprising:
receiving video information;
moving a substrate having an arrangement of LEDs;
sensing a position of said substrate;
generating information for a velocity of said substrate; and
driving zero or more LEDs in said arrangement of LEDs based on said position of said substrate, said velocity of said substrate, and said received video information.

11. The method of claim 10 wherein said receiving video information further comprises gamma correcting said received video information based on characteristics of said arrangement of LEDs.

12. The method of claim 10 wherein said moving is a sinusoidal movement.

13. The method of claim 10 wherein said driving zero or more LEDs in said arrangement of LEDs further comprises driving LEDs having three or more different emitted wavelengths.

14. The method of claim 13 wherein said driving zero or more LEDs in said arrangement of LEDs further comprises driving based on a predetermined brightness correction factor for a particular LED.

15. The method of claim 10 wherein moving said substrate further comprises moving said substrate such that one or more LEDs in said arrangement of LEDs spatially overlap.

16. The method of claim 15 further comprising driving zero or more LEDs in said arrangement of LEDs that spatially overlap creating a seamless display.

17. An apparatus comprising:
means for positioning a substrate having a plurality of LEDs;
means for sensing a position of said substrate;
means for receiving an input signal representative of an image;
means for compensating for particular LED characteristics;
means for compensating for a velocity of said substrate; and
means for driving said plurality of LEDs to create said image.

18. The apparatus of claim 17 further comprising means for gamma correction.

19. The apparatus of claim 17 wherein said means for positioning a substrate having a plurality of LEDs further comprises means for overlapping one or more LEDs spatially.

20. The apparatus of claim 19 wherein said means for driving said plurality of LEDs to create said image further comprises means for driving three or more groups of LEDs each capable of emitting an optical output at a different wavelength.
